(19) United States
(12) Patent Application Publication
(10) Pub. No.: US 2002/0003579 A1
(43) Pub. Date: Jan. 10, 2002

(54) Image sensing apparatus and control method thereof

(76) Inventor: Atsushi Inagaki, Kanagawa (JP)

Correspondence Address: MORGAN & FINNEGAN, L.L.P., 345 PARK AVENUE, NEW YORK, NY, 10154, US

(21) Appl. No.: 09/853,311

(22) Filed: May 11, 2001

(30) Foreign Application Priority Data
May 12, 2000 (JP) 2000-140233

(51) Int. Cl. H04N 3/14; H04N 5/232

(52) U.S. Cl. 348/312; 348/345; 348/333.11

(57) ABSTRACT

An image sensing apparatus comprises an image sensor that senses an image of a subject to obtain a sensed image; an operating frequency setting device that is capable of setting the operating frequency of said image sensing apparatus to at least any of a first operating frequency or a second operating frequency different from said first operating frequency; and a display unit that is capable of electrically displaying the sensed image obtained by the image sensor. The display unit is capable of display operations at any of said first or second operating frequency set by the operating frequency setting device.

### FIELD OF THE INVENTION

The present invention relates to an image sensing apparatus, such as a digital camera, and a control method thereof.

### BACKGROUND OF THE INVENTION

Conventionally, image sensing apparatus such as digital camera is known which records and reproduce a still picture or an moving picture with a recording medium such as a memory card having a solid state memory device as a recording medium. Some type of such an apparatus is provided with not only an optical finder (OVF) but also an electronic finder composed of a color liquid crystal panel or the like.

Such image sensing apparatus with an electronic finder often keeps sensed images displayed on the electronic finder successively even when the sensed images are not actually recorded or stored on a storage medium. Under these circumstances, the operations for recording the sensed images, such as focusing and image saving, start only when the shutter is pressed.

With the above-mentioned conventional image sensing apparatus equipped with an electronic finder, however, keeping sensed images displayed on the electronic finder during image sensing reduces the number of shots that can be taken because a large amount of power is consumed by the electronic finder, resulting in battery drain. On the other hand, lowering the operating frequency of the entire apparatus too much to reduce power consumption is not practical because it will increase the shutter time lag, the time required for the image sensing to be actually carried out after the shutter is pressed.

### SUMMARY OF THE INVENTION

The present invention has been made to solve the problems of the prior art described above. An object of the present invention, for example, is to achieve power savings without increasing the shutter time lag.

According to the present invention, there is provided an image sensing apparatus, comprising:

an image sensor that senses an image of a subject to obtain a sensed image;

an operating frequency setting device that is capable of setting the operating frequency of said image sensing apparatus to at least any of a first operating frequency or a second operating frequency different from said first operating frequency; and

a display unit that is capable of electrically displaying the sensed image obtained by said image sensor, the display unit being capable of display operations at any of said first or second operating frequency set by said operating frequency setting device.

According to the present invention, there is also provided a method for controlling an image sensing apparatus, comprising:

an image sensing step that senses an image of a subject to obtain a sensed image;

an operating frequency setting step that sets the operating frequency of said image sensing apparatus to at least any of a first operating frequency or a second operating frequency different from said first operating frequency at least; and

a display step that electrically displays the sensed image obtained in said image sensing step, in said display step said sensed image being displayed at said first or second operating frequency set in said operating frequency setting step.

According to the present invention, there is also provided a storage medium that stores a control program of an image sensing apparatus, said control program comprising:

a code for an image sensing step that senses an image of a subject to obtain a sensed image;

a code for an operating frequency setting step that sets the operating frequency of said image sensing apparatus to at least any of a first operating frequency or a second operating frequency different from said first operating frequency; and

a code for a display step that electrically displays the sensed image obtained in said image sensing step, in said display step said sensed image being displayed at said first or second operating frequency set in said operating frequency setting step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of the image sensing apparatus according to a first embodiment of the present invention; and

FIGS. 2 to 5 are flowcharts of image sensing processing.

### DETAILED DESCRIPTION OF THE PREFERRED EMBODIMENTS

Preferred embodiments of the present invention will now be described in detail in accordance with the accompanying drawings.

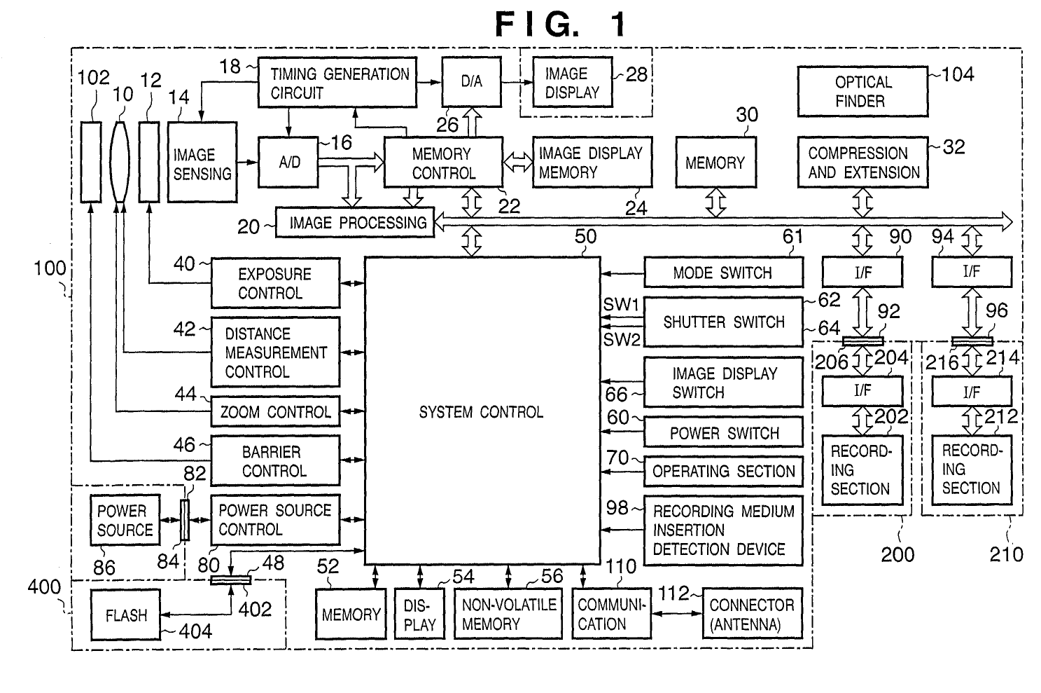

FIG. 1 is a block diagram showing the configuration of the image sensing apparatus according to a first embodiment of the present invention. This device is configured, for example, as a digital camera.

In the figure, reference numeral 100 denotes an image processing apparatus (image sensing apparatus), 10 denotes a taking lens consisting of a zoom lens and focusing lens, 12 denotes a shutter provided with an aperture adjustment function, and 14 denotes an image sensing device, which converts an optical image into an electrical signal. Reference numeral 16 denotes an A/D converter, which converts the analog signal output of the image sensing device 14 into a digital signal. Reference numeral 18 denotes a timing generator circuit, which supplies clock signals and control signals to the image sensing device 14 and A/D converter 16 and is controlled by a memory control circuit 22 and system control circuit 50.

Reference numeral 20 denotes an image processing circuit, which performs designated pixel interpolation or color conversion on the data from the A/D converter 16 or data from the memory control circuit 22. The image processing circuit 20 carries out designated computations using sensed image data. Based on the computed results, the system control circuit 50 instructs the exposure controller 40 and focusing controller 42 to perform TTL (through-the-lens) mode AF (autofocusing), AE (automatic exposure), and EF (preflashing) processes. Moreover, the image processing circuit 20 carries out designated computations using sensed image data, and based on the computed results, it performs a TTL mode AWB (automatic white balance) adjustment.

Reference numeral 22 denotes the memory control circuit, which controls the A/D converter 16, the timing generator circuit 18, the image processing circuit 20, an image display memory 24, a D/A converter 26, a memory 30, and a compression/decompression circuit 32.

The data from the A/D converter 16 is written into the image display memory 24 or memory 30 via the image processing circuit 20 and memory control circuit 22 or directly via the memory control circuit 22.

Reference numeral 24 denotes the image display memory, 26 denotes the D/A converter, and 28 denotes an image display section constituted by a TFT-LCD (thin film transistor liquid crystal display) and the like. The image data written into the image display memory 24 is displayed by the image display section 28 via the D/A converter 26. The image display section 28 can achieve the function of an electronic finder if it displays sensed image data successively. Also, it can turn on and off the display at any time in accordance with instructions from the system control circuit 50. Turning off the display helps reduce the power consumption of the image processing apparatus 100 greatly.

Reference numeral 30 denotes a memory for storing still pictures or moving pictures as well as voice data. It has enough storage capacity to store a designated number of still pictures or designated minutes of moving pictures. This allows a large volume of image data to be written into the memory 30 at high speed even during sequential photography or panoramic photography which involves taking a series of still pictures successively. The memory 30 can also be used as a working area by the system control circuit 50.

Reference numeral 32 denotes a compression/decompression circuit, which compresses and decompresses image data through adaptive discrete cosine transform (ADCT) or the like. The circuit compresses or decompresses image data read from the memory 30 and writes the resulting data back into the memory 30.

Reference numeral 40 denotes an exposure controller, which controls the shutter 12 and can have a flash control function if linked with a flash 404. Reference numeral 42 denotes a focusing controller, which controls the focusing of the taking lens 10. The exposure controller 40 and focusing controller 42 are controlled by means of a TTL system. The system control circuit 50 controls the exposure controller 40 and focusing controller 42, based on the results of the computations performed by the image processing circuit 20 on sensed image data.

Reference numeral 44 denotes a zoom controller, which controls the zooming of the taking lens 10. Reference numeral 46 denotes a barrier controller, which controls a protector 102 that serves as a barrier. Reference numeral 48 denotes a connector, also known as an accessory shoe, which incorporates an electric contact and mechanical clamp for flash apparatus 400.

Reference numeral 50 denotes a system control circuit, which controls the entire image processing apparatus 100. Reference numeral 52 denotes a memory, which stores the constants, variables, programs, etc. for the operation of the system control circuit 50.

Reference numeral 54 denotes a display section, which is constituted by a liquid crystal display, speaker, etc. This section displays operating state, messages, and the like using characters, images, voice, etc. according to the program executed by the system control circuit 50. The display section 54 is installed at one or more readily visible locations near input devices of the image processing apparatus 100 and constituted by, for example, a combination of an LCD (liquid crystal display), LEDs (light emitting diodes), sound-producing elements and the like.

Reference numeral 56 denotes an electrically erasable programmable non-volatile memory such as an EEPRO (electrically erasable and programmable read only memory) Reference numerals 60, 61, 62, 64, 66, and 70 denote input devices, via which various instructions for the system control circuit 50 are entered and which are constituted by one or more switches, dials, touch panels, pointing devices employing line-of-sight detection, speech recognition devices, etc. or their combinations.

Now the input devices 60, 61, 62, 64, 66, and 70 will be described concretely.

Reference numeral 60 denotes a power switch that turns on and off the image processing apparatus 100. Reference numeral 61 denotes a mode dial switch, which allows selection among various modes such as automatic shooting mode, manual shooting mode, panoramic photography mode, playback mode.

Reference numeral 62 denotes a shutter switch (SW1), which turns on halfway through the release operation of a shutter button (not shown) and gives the command to start AF (autofocusing), AE (automatic exposure), AWB (automatic white balance), EF (preflashing), and other processes.

Reference numeral 64 denotes a shutter switch (SW2), which turns on when the release operation of the shutter button (not shown) is completed and triggers a sequence of processes: an exposure process of writing the signals read out of the image sensing device 12 into the memory 30 as image data through the A/D converter 16 and memory control circuit 22; developing process using the computations carried out in the image processing circuit 20 and memory control circuit 22; and recording process of reading image data out of the memory 30, compressing it in the compression/decompression circuit 32, and writing it in a recording medium 200 or recording medium 210.

Reference numeral 66 denotes an image display ON/OFF switch, which allows the image display section 28 to be set to ON or OFF. This function makes it possible to shut off the current to the image display section constituted by an TFT-LCD, etc. during photography by the use of an optical finder 104, and thereby save power. The ON/OFF setting of the image display section 28 is stored as an image display flag (ON/OFF) in a memory 52. The user can set the image display flag at will using the input device 70. The setting may also be stored in an internal memory of the system control circuit 50.

A zoom switch (not shown) instructs zooming of the taking lens 10.

Reference numeral 70 denotes the input device, which consists of various buttons, a touch panel, etc., including a menu button, set button, macro button, multi-screen playback/page-break button, flash setting button, single-shot/multi-shot self-timer switchover button, menu forward (+) button, menu backward (−) button, image forward (+) button, image backward (−) button, menu up button, menu down button, picture quality selection button, exposure compensation button, date/time setting button, etc.

Reference numeral 80 denotes a power supply controller, which is constituted by a battery detector circuit, DC/DC converter, and switching circuit for switching the block to turn on. This controller detects the presence or absence of a battery, type of battery, and remaining battery capacity, and supplies required voltages for required periods of time to various parts of the system, including the recording media 200 and 210, by controlling the DC/DC converter, based on the results of the detection and instructions from the system control circuit 50.

Reference numerals 82 and 84 denote connectors while reference numeral 86 denotes a power supply, which is constituted by a primary battery such as an alkaline or lithium cell, secondary battery such as an NiCd, NiMH, or Li cell, AC adaptor, etc.

Reference numerals 90 and 94 denote interfaces (I/F) to the recording media 200 and 210 such as memory cards or hard disks while reference numerals 92 and 96 denote connectors for connecting to the recording media 200 and 210 such as memory cards or hard disks.

Reference numeral 98 denotes a media detector, which detects whether the recording medium 200 or 210 has been inserted in the connectors 92 and/or 96.

This embodiment has two sets of an interface and connector for connecting storage media. Of course, the present invention may be configured to have either one set or multiple sets of an interface and connector for connecting recording media. Also, it may be configured to have a combination of interfaces and connectors of different standards.

Cards that comply with PCMCIA, CF (compact flash), or other similar standards may be used as the interfaces and connectors. When cards that comply with PCMCIA, CF (compact flash), or other similar standards are used for the interfaces 90 and 94 and connectors 92 and 96, if communications cards such as a LAN card, modem card, USB card, IEEE1394 card, P1284 card, SCSI card, and/or telecommunication card for PHS are connected, image data and accompanying management information can be exchanged with other computers or peripherals such as printers.

Reference numeral 102 denotes the barrier or protector 102, which covers an image sensing section including the taking lens 10 of the image processing apparatus 100 to protect the image sensing section from contamination and damage. Reference numeral 104 denotes the optical finder, which allows the user to take photographs only by using the optical finder 104 without using the electronic finder function of the image display section 28. Besides, the optical finder 104 incorporates some of the functions of the display section 54: for example, an in-focus indicator function, blur warning function, flash charge indicator function, shutter speed indicator function, f-number indicator function, exposure compensation indicator function.

Reference numeral 110 denotes a communications section, which has various communications functions such as RS232C, USB, IEEE1394, P1284, SCSI, modem, LAN, and wireless communications functions. Reference numeral 112 denotes either a connector used to connect the image processing apparatus 100 to other equipment through the communications section 110 or an antenna used for wireless communications.

Reference numeral 200 denotes the storage medium such as a memory card or hard disk. The storage medium 200 has a recording section 202 constituted by a semiconductor memory, magnetic disk, or the like; an interface (I/F) 204 to the image processing apparatus 100; and a connector 206 for connecting to the image processing apparatus 100.

Reference numeral 210 denotes the storage medium such as a memory card or hard disk. The storage medium 210 has a recording section 212 constituted by a semiconductor memory, magnetic disk, or the like; an interface (I/F) 214 to the image processing apparatus 100; and a connector 216 for connecting to the image processing apparatus 100.

Reference numeral 400 denotes the flash apparatus and 402 denotes a connector for connecting to the accessory shoe of the image processing apparatus 100. Reference numeral 404 denotes a flash, which is provided with an AF fill-flash function and flash control function.

With the above configuration, if the mode dial switch 61 is set at image sensing mode, the image sensing can be carried out with the shutter switch (SW1) 62 and shutter switch (SW2) 64. The system control circuit 50 is normally ready for photography. If a press of the shutter switch (SW1) 62 is detected, the exposure controller 40 controls exposure and the focusing controller 42 controls focusing. When these control operations are completed, the system gets ready to start exposure. When a press of the shutter switch (SW2) 64 is detected, the exposure is started. The sensed image acquired by photography is stored in the memory 30 via the image sensing device 14, A/D converter 16, image processing circuit 20, and memory control circuit 22. The recorded image stored in the memory 30 are compressed by the compression/decompression circuit 32 as required, and stored again in the memory 30. The system control circuit 50 finishes photography in this state.

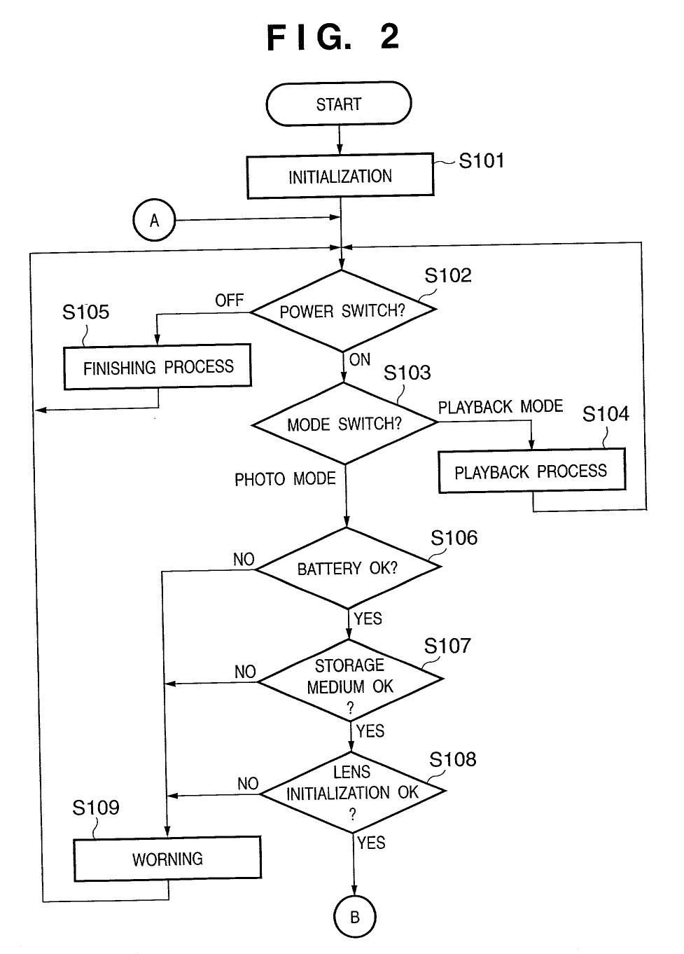

FIGS. 2 to 5 are drawings showing flowcharts of the image sensing processing according to this embodiment.

First, during initialization, i.e., upon power-up after a battery replacement or the like, the system control circuit 50 initializes flags and control variables (Step S101). Next, the system control circuit 50 checks the state of the power switch 60 to see if it is set at ON (Step S102). If the power switch 60 is set at OFF, the system control circuit 50 performs finishing processes (Step S105). Specifically, it finishes the display in the display sections, closes the barrier of the protector 102 to protect the image sensing section, stores necessary set values and mode settings as well as the settings of necessary parameters including flags and control variables in the non-volatile memory 56, shuts off unnecessary power to individual sections of the image processing apparatus 100 including the image display section 28 by means of the power supply controller 80, and performs other designated finishing processes. Then the flow returns to the Step S102.

On the other hand, if it is found in the Step S102 that the power switch 60 is set at ON, the system control circuit 50 checks the setting position (either photo mode or playback mode) of the mode dial switch 61 to see if it is set at photo mode (Step S103). If it is found that the mode dial switch 61 is set at playback mode, the system control circuit 50 runs the playback process (Step S104) and returns to the Step S102.

If the mode dial switch 61 is set at photo mode, the system control circuit 50 checks the remaining capacity and operating state of the power supply 86 by using the power supply controller 80 to see if the operation of the image processing apparatus 100 will not be hampered (Step S106). If it is judged that the operation of the image processing apparatus 100 will be hampered, the system control circuit 50 goes to Step S109. If it is judged that the operation of the image processing apparatus 100 will not be hampered, the system control circuit 50 checks the operating state of the recording medium 200 or 210 to see if the operation of the image processing apparatus 100, especially the recording and playback operations of image data with respect to the recording medium 200 or 210, will not be hampered (Step S107). If it is judged that the operation of the image processing apparatus 100 will be hampered, the system control circuit 50 goes to Step S109. If it is judged that the operation of the image processing apparatus 100 will not be hampered, the system control circuit 50 initializes the taking lens 10 and checks if it operates normally (Step S108). If it is judged that the taking lens 10 does not operate normally, the system control circuit 50 goes to Step S109.

In Step S109, the system control circuit 50 displays warnings in the display section 54, etc. using images or voice. Then the flow returns to the Step S102.

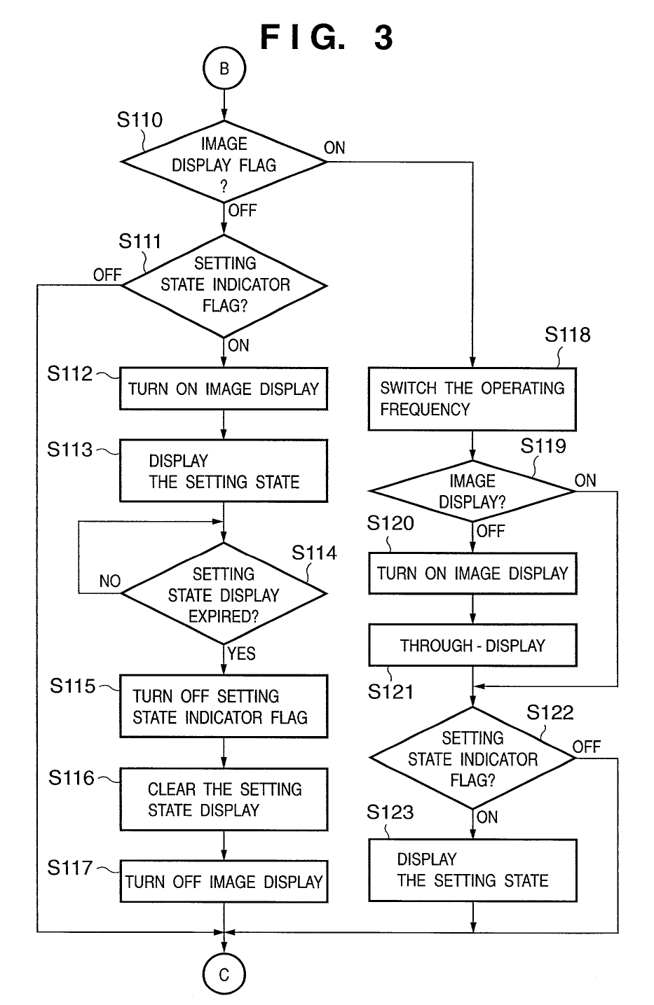

On the other hand, if it is judged in the Step S108 that the taking lens 10 operates normally, the system control circuit 50 checks if the image display flag is ON (Step S110 in FIG. 3). If it is found that the image display flag is ON, the system control circuit 50 switches the operating frequency W of the present apparatus as a whole to a first operating frequency W1 (Step S118).

The operating frequency W of the present apparatus is set either at the first operating frequency W1 or at a second operating frequency W2 higher than it. At the start of processing (initialization) in FIG. 2, it is set at the second operating frequency W2. Therefore, in the Step S118, the operating frequency W is switched from the second operating frequency W2 to the first operating frequency W1, the lower frequency. This reduces power consumption. The switching of the operating frequency W is controlled by the system control circuit 50.

Next, the system control circuit 50 checks the state of image display in the image display section 28 to see if the image display in the image display section 28 is ON (Step S119). If it is found that the image display in the image display section 28 is not ON, the system control circuit 50 turns on the image display in the image display section 28 (Step S120), puts it in through-display mode so that sensed image data will be displayed successively (Step S121), and goes to Step S122. On the other hand, if it is found that the image display in the image display section 28 is ON, the system control circuit 50 goes to the Step S122 immediately. In the through-display mode described above, the data written successively into the image display memory 24 via the image sensing device 14, A/D converter 16, image processing circuit 20, and memory control circuit 22 is displayed successively in the image display section 28 via the memory control circuit 22 and the D/A converter 26 to implement the function of an electronic finder.

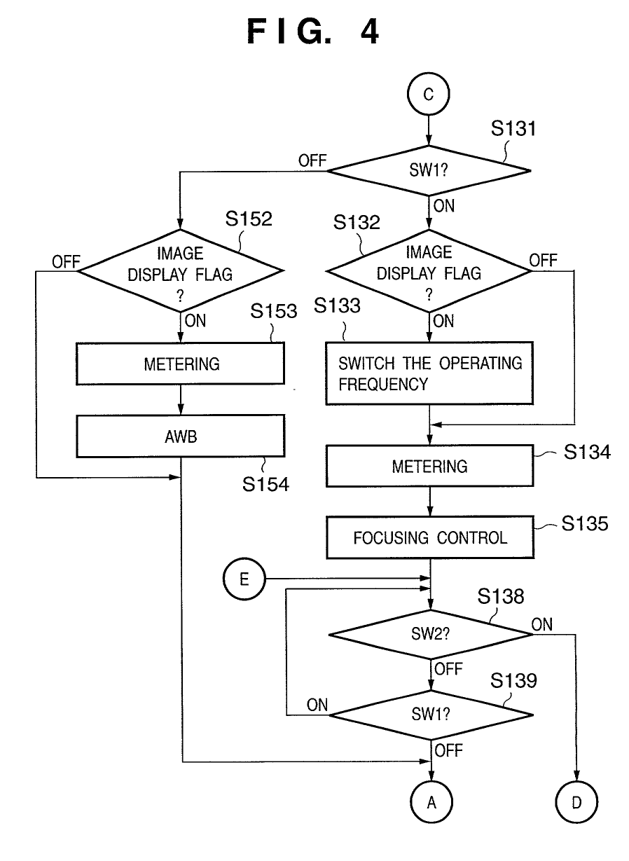

In the following Step S122, the system control circuit 50 checks to see if a setting state indicator flag is ON. If it is ON, the system control circuit 50 displays the setting state in the image display section 28 (Step S123) and goes to Step S131 in FIG. 4. On the other hand, if the setting state indicator flag is not ON, the system control circuit 50 goes to the Step S131 immediately.

If it is found in the Step S110 that the image display flag is not ON (i.e., the flag is OFF), the system control circuit 50 checks to see if the setting state indicator flag is ON (Step S111). If the setting state indicator flag is not ON, the system control circuit 50 goes to the Step S131 immediately. If the setting state indicator flag is ON, the system control circuit 50 turns on the image display in the image display section 28 (Step S112), displays the setting state in the image display section 28 (Step S113), and checks to see if a preset setting state display time has expired (Step S114). The system control circuit 50 continues the checking until the setting state display time expires. When the setting state display time expires, the system control circuit 50 turns off the setting state indicator flag (Step S115), clears the setting state display in the image display section 28 (Step S116), turns off the image display in the image display section 28 (Step S117), and goes to the Step S131.

In the following Step S131 in FIG. 4, the system control circuit 50 checks to see if the shutter switch (SW1) 62 is ON. If it is found that SW1 is not ON, the system control circuit 50 checks to see if the image display flag is ON (Step S152). If it is found that the image display flag is ON, the system control circuit 50 performs metering (Step S153) and AWB adjustment (Step S154) and returns to the Step S102 in FIG. 2. On the other hand, if it is found that the image display flag is not ON, the system control circuit 50 returns to the Step S102 immediately.

If it is found in the Step S131 that the shutter switch (SW1) 62 is ON, the system control circuit 50 checks to see if the image display flag is ON (Step S132). If it is found that the image display flag is ON, the system control circuit 50 goes to Step S134. If it is found that the image display flag is not ON, the system control circuit 50 switches the operating frequency W (Step S133) before going to the Step S134.

This process of switching the operating frequency W changes the operating frequency W of the present apparatus as a whole from the first operating frequency W1 to the second operating frequency W2. Thus, the operating frequency W returns to its normal rate. This ensures that subsequent recording operations of sensed images, including metering, focusing control, and recording/saving operations, will be carried out at high speed.

Next, in Step S134, metering is performed. During metering, flash settings are made as required. In the following Step S135, focusing control is performed to focus the taking lens on the subject.

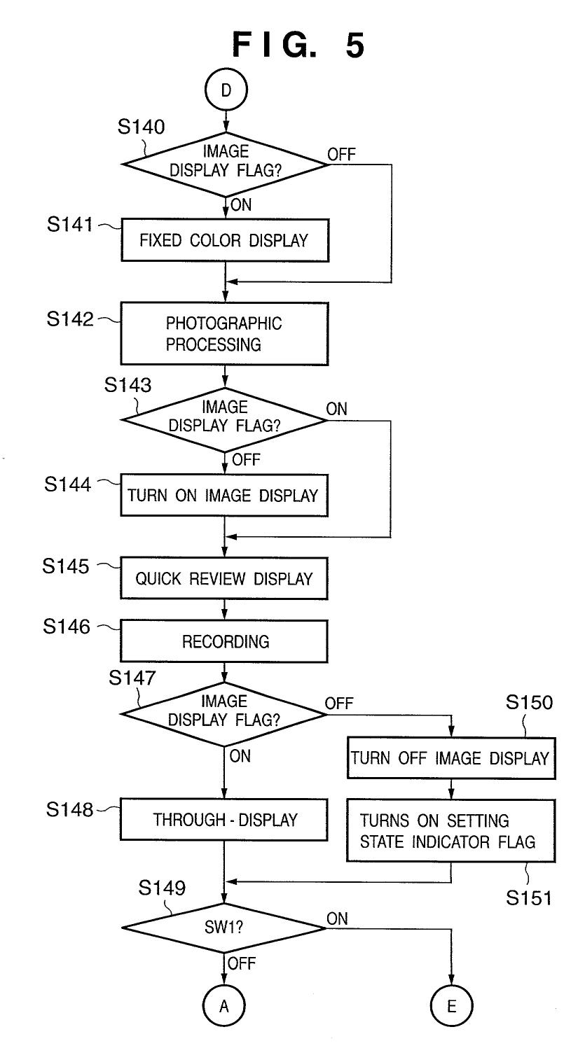

In the following Step S138, the system control circuit 50 checks to see if the shutter switch (SW2) 64 is ON. If it is found that SW2 is not ON, the system control circuit 50 checks to see if the shutter switch (SW1) 62 is ON (Step S139). If it is found that SW1 is not ON (has been turned off), the system control circuit 50 returns to the Step S102. If it is found that SW1 is ON (remains ON), the system control circuit 50 returns to the Step S138. If it is found in the Step S138 that the shutter switch (SW2) 64 is ON, the system control circuit 50 checks to see if the image display flag is ON (Step S140 in FIG. 5).

If it is found that the image display flag is ON, the system control circuit 50 sets the display mode in the image display section 28 to fixed color display mode (Step S141) and goes to Step S142. If it is found that the image display flag is not ON, the system control circuit 50 goes to the Step S142 immediately. In the fixed color display mode, instead of the sensed image data written into the image display memory 24 via the image sensing device 14, A/D converter 16, image processing circuit 20, and memory control circuit 22; fixed-color image data is received by the image display section 28 via the memory control circuit 22 and D/A converter 26 to display a fixed-color picture.

In the following Step S142, photographic processing is carried out. Specifically, the system control circuit 50 carries out exposure processing which involves writing photographic image data into the memory 30 via the image sensing device 14, A/D converter 16, image processing circuit 20, and memory control circuit 22 or directly from the A/D converter 16 via the memory control circuit 22 and performs developing which involves reading the image data from the memory 30 using the memory control circuit 22 and, as required, image processing circuit 20 to perform various processing.

Next, the system control circuit 50 checks to see if the image display flag is ON (Step S143). If it is found that the image display flag is not ON, the system control circuit 50 turns on the image display in the image display section 28 (Step S144) and goes to Step S145. If it is found that the image display flag is ON, the system control circuit 50 goes to Step S145 immediately.

In Step S145, the system control circuit 50 displays a quick review. If the Step S144 is skipped, the image display section 28 continues to display the sensed image, serving the function of an electronic finder, and the quick review is also displayed immediately after shooting. On the other hand, if the Step S144 is performed, the sensed image is not displayed for a quick review until just after shooting.

Next, the recording process of the sensed image data is carried out (Step S146). Specifically, this process involves reading the sensed image data from the memory 30, performing various image processing on it using the memory control circuit 22 and, as required, image processing circuit 20, compressing it by the compression/decompression circuit 32 according to the mode setting, and then writing it into the recording medium 200 or 210.

Next, the system control circuit 50 checks to see if the image display flag is ON (Step S147). If it is found that the image display flag is ON, the system control circuit 50 sets the display mode to through-display (Step S148) and goes to Step S149. In the through-display mode, the sensed image data for the next shot is displayed successively after a quick review of the sensed image.

On the other hand, if it is found in the Step S147 that the image display flag is not ON, the system control circuit 50 turns off the image display in the image display section 28 (Step S150), turns on the setting state indicator flag (Step S151), and goes to the Step S149.

In the following Step S149, the system control circuit 50 checks to see if the shutter switch (SW1) 62 is ON. If it is found that SW1 is ON, the system control circuit 50 returns to the Step S138 to get ready for shooting. If it is found that SW1 is not ON (has been turned off), this means that the sequence of photographic operations is finished and the system control circuit 50 returns to the Step S102.

According to this processing, if the image display flag is ON, the operating frequency W of the apparatus is set at the lower, first operating frequency W1 until the shutter switch (SW1) 62 is pressed, and when the SW1 is pressed, the operating frequency W of the apparatus is switched to the second operating frequency W2, the normal frequency, before metering, focusing control, etc. On the other hand, if the image display flag is OFF, the operating frequency W of the apparatus is constantly set at the normal, second operating frequency W2.

According to this embodiment, when a sensed image is displayed for image sensing, the apparatus operates at the lower, first operating frequency W1 until the shutter switch (SW1) 62 is pressed triggering the operations (metering, focusing control, saving, etc.) for recording the sensed image. This effectively reduces power consumption, which tends to be increased by the image display in the image display section 28. Besides, during the recording of sensed images, the apparatus operates at the normal, second operating frequency W2 to increase the processing speed and reduce the shutter time lag. Thus, power savings can be achieved without increasing the shutter time lag.

When the image sensing is carried out without sensed image display, since the image display section 28 consumes less power from the beginning, the decrease in the operating frequency is less effective in power savings. Therefore, the apparatus is always made to operate at the normal, second operating frequency W2 to give priority to the processing speed and avoid increasing the shutter time lag more reliably.

Although in this embodiment, the process of lowering the operating frequency W to the first operating frequency W1 is applied to the entire apparatus, it is also possible to apply this process only to the operations (image sensing operation by the image sensing device 14, display operation by the image display section 28, etc.) directly relevant to the image display in the image display section 28.

Although in this embodiment, the timing of switching the operating frequency W from the first operating frequency W1 back to the second operating frequency W2 is provided after SW1 is pressed but before the metering (Step S134) to reduce the shutter time lag effectively, this timing is not limited to this time interval. It may be provided before the metering (Step S134), or after the shutter switch (SW2) 64 is pressed (Step S138) but before the photographic processing (Step S142).

As described above, when carrying out the image sensing while displaying an image, this embodiment can achieve power savings without increasing the shutter time lag, by using the low operating frequency before the recording operation is started or except during the recording operation.

When the sensed image is not displayed and thus less power saving effect is available, this embodiment can give priority to the processing speed and avoid increasing the shutter time lag more reliably.

Needless to say, the object of the present invention can also be achieved by a storage medium containing the software program code that implements the functions of the above embodiments: it is supplied to an image sensing apparatus (image sensing apparatus 100), whose computer (or a CPU or MPU) (system control circuit 50) then reads the program code out of the storage medium and executes it.

In that case, the program code itself read out from the storage medium will implement the new functions of the above embodiments, and the storage medium which stores the program code will constitute the present invention.

As the storage medium for supplying the program code, for example, a floppy disk, hard disk, optical disk, magneto-optical disk, CD-ROM, CD-R, magnetic tape, non-volatile memory card, ROM, or the like may be used.

The functions of the above embodiments may be implemented not only by the program code read out and executed by the computer, but also by part or all of the actual processing executed, in accordance with instructions from the program code, by an OS (operating system) running on the computer.

Furthermore, the functions of the above embodiments may also be implemented by part or all of the actual processing executed by a CPU or the like contained in a function expansion card inserted in the computer or a function expansion unit connected to the computer if the processing is performed in accordance with instructions from the program code that has been read out of the storage medium and written into memory on the function expansion card or unit.

As many apparently widely different embodiments of the present invention can be made without departing from the spirit and scope thereof, it is to be understood that the invention is not limited to the specific embodiments thereof except as defined in the claims.

What is claimed is:

1. An image sensing apparatus, comprising:
an image sensor that senses an image of a subject to obtain a sensed image;
an operating frequency setting device that is capable of setting the operating frequency of said image sensing apparatus to at least any of a first operating frequency or a second operating frequency different from said first operating frequency; and
a display unit that is capable of electrically displaying the sensed image obtained by said image sensor, the display unit being capable of display operations at any of said first or second operating frequency set by said operating frequency setting device.

2. The image sensing apparatus according to claim 1, wherein:
said second operating frequency is lower than said first operating frequency and said operating frequency setting device sets said first operating frequency when said sensed image is recorded.

3. The image sensing apparatus according to claim 2, wherein:
said display unit is capable of displaying the sensed image obtained from said image sensor at any of said first or second operating frequency.

4. The image sensing apparatus according to claim 2, wherein:
said operating frequency setting device switches between said first and second operating frequencies in a case where said display unit is operating.

5. The image sensing apparatus according to claim 1, wherein:
said second operating frequency is lower than said first operating frequency and said operating frequency setting device sets said first operating frequency when photography is performed.

6. The image sensing apparatus according to claim 5, wherein:
said display unit is capable of displaying the sensed image obtained from said image sensor at any of said first or second operating frequency.

7. The image sensing apparatus according to claim 5, wherein:
said operating frequency setting device switches between said first and second operating frequencies in a case where said display unit is operating.

8. The image sensing apparatus according to claim 1, wherein:
said display unit is capable of displaying the sensed image obtained from said image sensor at any of said first or second operating frequency.

9. The image sensing apparatus according to claim 1, wherein:
said operating frequency setting device switches between said first and second operating frequencies in a case where said display unit is operating.

10. The image sensing apparatus according to claim 1, further comprising:
a photography triggering member for giving a command to start photography; and wherein
said operating frequency setting device switches between said first and second operating frequencies in response to an operation of said photography triggering member.

11. The image sensing apparatus according to claim 10, further comprising:
a focusing device for performing a focus adjustment in response to an operation of said photography triggering member.

12. The image sensing apparatus according to claim 10, further comprising:
a metering device for performing a metering operation in response to an operation of said photography triggering member.

13. A method for controlling an image sensing apparatus, comprising:
an image sensing step that senses an image of a subject to obtain a sensed image;
an operating frequency setting step that sets the operating frequency of said image sensing apparatus to at least any of a first operating frequency or a second operating frequency different from said first operating frequency at least; and
a display step that electrically displays the sensed image obtained in said image sensing step, in said display step said sensed image being displayed at said first or second operating frequency set in said operating frequency setting step.

14. The method for controlling an image sensing apparatus according to claim 13, wherein:
said second operating frequency is lower than said first operating frequency; and
in said operating frequency setting step, said first operating frequency is set when said sensed image is recorded.

15. The method for controlling an image sensing apparatus according to claim 14, wherein:
in said display step, the sensed image obtained in said image sensing step is displayed at said first or second operating frequency set in said operating frequency setting step.

16. The method for controlling an image sensing apparatus according to claim 14, wherein:
in said operating frequency setting step, switching between said first and second operating frequencies is done in a case where said display step is operated.

17. The method for controlling an image sensing apparatus according to claim 13, wherein:
said second operating frequency is lower than said first operating frequency; and
in said operating frequency setting step, said first operating frequency is set when photography is performed.

18. The method for controlling an image sensing apparatus according to claim 17, wherein:
in said display step, the sensed image obtained from said image sensor is displayed at said first or second operating frequency set in said operating frequency setting step.

19. The method for controlling an image sensing apparatus according to claim 17, wherein:
in said operating frequency setting step, switching between said first and second operating frequencies is done in a case where said display step is operated.

20. The method for controlling an image sensing apparatus according to claim 13, wherein:
in said display step, the sensed image obtained in said image sensing step is displayed at any of said first or second operating frequency set in said operating frequency setting step.

21. The method for controlling an image sensing apparatus according to claim 13, wherein:
in said operating frequency setting step, switching between said first and second operating frequencies is done in a case where said display step is operated.

22. The method for controlling an image sensing apparatus according to claim 13, further comprising:
a photography triggering step that gives a command to start a photography, and wherein
in said operating frequency setting step, switching between said first and second operating frequencies is done in response to said command to start a photography.

23. The method for controlling an image sensing apparatus according to claim 22, further comprising:
a focusing step that performs a focus adjustment in response to said command to start a photography.

24. The method for controlling an image sensing apparatus according to claim 22, further comprising:
a metering step that performs a metering operation in response to said command to start a photography.

25. A storage medium that stores a control program of an image sensing apparatus, said control program comprising:
a code for an image sensing step that senses an image of a subject to obtain a sensed image;
a code for an operating frequency setting step that sets the operating frequency of said image sensing apparatus to at least any of a first operating frequency or a second operating frequency different from said first operating frequency; and
a code for a display step that electrically displays the sensed image obtained in said image sensing step, in said display step said sensed image being displayed at said first or second operating frequency set in said operating frequency setting step.

26. The storage medium according to claim 25, wherein:
said second operating frequency is lower than said first operating frequency; and
in said operating frequency setting step, said first operating frequency is set when said sensed image is recorded.

27. The storage medium according to claim 26, wherein:
in said display step, the sensed image obtained in said image sensing step is displayed at said first or second operating frequency set in said operating frequency setting step.

28. The storage medium according to claim 26, wherein:
in said operating frequency setting step, switching between said first and second operating frequencies is done in a case where said display step is operated.

29. The storage medium according to claim 25, wherein:
said second operating frequency is lower than said first operating frequency; and
in said operating frequency setting step, said first operating frequency is set when during photography is performed.

30. The storage medium according to claim 29, wherein:
in said display step, the sensed image obtained in said image sensing step is displayed at said first or second operating frequency set in said operating frequency setting step.

31. The storage medium according to claim 29, wherein:
in said operating frequency setting step, switching between said first and second operating frequencies is done in a case where said display step is operated.

32. The storage medium according to claim 25, wherein:
in said display step, the sensed image obtained in said image sensing step is displayed at any of said first or second operating frequency set in said operating frequency setting step.

33. The storage medium according to claim 25, wherein:
in said operating frequency setting step, switching between said first and second operating frequencies is done in a case where said display step is operated.

34. The storage medium according to claim 25, wherein:
said control program further comprises a code for a photography triggering step that gives a command to start a photography; and
in said operating frequency setting step, switching between said first and second operating frequencies is done in response to said command to start a photography.

35. The storage medium according to claim 34, wherein:
said control program further comprises a code for a focusing step that performs a focus adjustment in response to said command to start a photography.

36. The storage medium according to claim 34, wherein:
said control program further comprises a code for a metering step that performs a metering operation in response to said command to start a photography.
